(19) United States
(12) Patent Application Publication
(10) Pub. No.: US 2017/0249928 A1
(43) Pub. Date: Aug. 31, 2017

(54) TAILPIECE FOR A STRING INSTRUMENT

(71) Applicant: Chien Che Kenneth KUO, Norwalk, CT (US)

(72) Inventor: Chien Che Kenneth KUO, Norwalk, CT (US)

(21) Appl. No.: 15/444,224

(22) Filed: Feb. 27, 2017

Related U.S. Application Data
(60) Provisional application No. 62/300,366, filed on Feb. 26, 2016.

(51) Int. Cl. G10D 3/12; G10D 1/02

(52) U.S. Cl. CPC G10D 3/12; G10D 1/02

(57) ABSTRACT

Disclosed herein are improved tailpieces for use with a stringed instrument. In some embodiments, the improved tailpieces provide for a better and adjustable sound quality. In other embodiments, the improved tailpieces provide for facile removal and attachment to a tailgut. In other embodiments, the tailpiece connection to the tailgut is adjustable. In further embodiments, the tailpiece has a detachable weight that is associated with a back face thereof.

### BACKGROUND

The invention relates to a novel tailpiece to enhance sound characteristics of a string instrument.

String instruments, such as a cello, are typically made from wood, although other materials such as carbon fiber or aluminum may be used. FIGS. 1A-1B depict a traditional cello 10 with a top 20 made from spruce wood, and a neck 15, back 17 and sides 19 made of maple wood. Other woods, such as poplar or willow, are sometimes used for the back 17 and sides 19. Less expensive cellos frequently have tops 20 and backs 17 made of laminated wood. The top 20 and back 17 are traditionally hand-carved, though less expensive cellos are often machine-produced. The sides 19, or ribs, are made by heating the wood and bending it around forms. A main body 11 of the cello 10 has a wide top bout, narrow middle formed by two C-bouts, and wide bottom bout, with a bridge 26 and F holes 24 just below the middle.

Above the main body 11 is the carved neck 15, which leads to a pegbox 13 and a scroll 12. The neck 15, pegbox 13, and scroll 12 are typically carved out of a single piece of wood, such as maple wood. A fingerboard 18 is glued to the neck 15 and extends over the main body 11. A nut 16 is a raised piece of wood that is fitted where the fingerboard 18 meets the pegbox 13, in which strings 22 rest in shallow slots to keep them the correct distance apart. The pegbox 13 houses four tapered tuning pegs 14, one for each string 22. The pegs 14 are used to tune the cello 10 by either tightening or loosening the strings 22.

The tailpiece 28 and endpin 30 are found in the lower part of the cello 10. Tailgut 31 is used to secure a base of the tailpiece 28 to an end button 33 at the base of the cello 10. The tailpiece 28 is traditionally made of ebony or another hard wood, but can also be made of plastic or steel. The tailpiece 28 attaches the strings 22 to the lower end of the cello 10, and can have one or more string puller arms 29, to adjust an after length 27 of the strings 22 (i.e. a length of the strings 22 between the tailpiece 28 and the bridge 26). The endpin 30 supports the cello 10 in the playing position.

FIG. 2A is a rear view of a tailpiece 28 used in the conventional cello 10 of FIG. 1A. The tailpiece 28 is made from ebony wood. The tailpiece 28 includes a top end 42, a bottom end 44, a left side 46 and a right side 48. The tailpiece also has a back face that faces toward the stringed instrument and a front face that faces away from the stringed instrument. Four openings 41 are provided in the tailpiece 28 to receive and secure one end of the four strings 22 of the cello 10. The tailpiece 28 also includes a pair of spaced apart openings 64 to receive opposing ends of the tailgut 31. A cavity 40 is formed in an upper half of the tailpiece 28. FIG. 2B is a cross-sectional view of the tailpiece of FIG. 2A taken along the line 2B-2B and confirms that the cavity 40 does not extend beyond the upper half of the tailpiece 28.

FIG. 3A is a rear view of a tailpiece 28′ used in the conventional cello 10 of FIG. 1A. The tailpiece 28′ is made from plastic material. The tailpiece 28′ includes similar features as those discussed above with respect to the tailpiece 28 of FIG. 2A. Additionally, the tailpiece 28′ of FIG. 3A includes the string puller arm 29 in each opening 41, to adjustably vary the length of each string 22. The tailpiece 28′ includes a cavity 40′ that extends from the top end 42 to the tailgut openings 64 located between the top end 42 and the bottom end 44. FIG. 3B is a cross-sectional view of the tailpiece 28′ of FIG. 3A taken along the line 3B-3B. As shown in FIG. 3B, the tailpiece 28 has a thickness 62 and forms the cavity 40′. Additionally, the cavity 40′ has a depth 56 which varies along the length of the cavity 40′ from the top end 42 to the tailgut openings 64.

### BRIEF DESCRIPTION OF THE DRAWINGS

FIG. 1A is a front view of a conventional cello;

FIG. 1B is a side view of the conventional cello of FIG. 1A;

FIG. 2A is a rear view of a conventional tailpiece used in the cello of FIG. 1A;

FIG. 2B is a cross-sectional view of the tailpiece of FIG. 2A taken along the line 2B-2B;

FIG. 3A is a rear view of a conventional tailpiece used in the cello of FIG. 1A;

FIG. 3B is a cross-sectional view of the tailpiece of FIG. 3A taken along the line 3B-3B;

FIG. 4A is a rear view of a tailpiece according to one embodiment of the present invention;

FIG. 4B is a front view the tailpiece of FIG. 4A;

FIG. 4C is a side view of a string puller arm for use with the tailpiece of FIG. 4A, according to one embodiment of the present invention;

FIG. 4D is a front view of the string puller arm of FIG. 4C used in the tailpiece of FIG. 4A, according to one embodiment of the present invention;

FIG. 4E is a cross-sectional view of the tailpiece of FIG. 4A taken along the line 4E-4E;

FIG. 4F is an end perspective view of the tailpiece of FIG. 4B, according to one embodiment of the present invention;

FIG. 4G is a partial side view of a bridge of the conventional cello of FIG. 1A;

FIG. 5 is a rear perspective view of a tailpiece according to one embodiment of the present invention;

FIG. 6A is a side view of a string puller arm for use with a tailpiece according to one embodiment of the present invention;

FIG. 6B is a perspective view of a relative position of multiple hooks of the string puller arm of FIG. 6A in a tailpiece according to one embodiment of the present invention; and

FIG. 7 is a top view of a plurality of tailpieces and adjustable weights according to one embodiment of the present invention.

### DETAILED DESCRIPTION

As previously discussed, conventional tailpieces are only made from certain types of materials, including ebony or another hard wood, plastic or steel. As appreciated by one skilled in the art, the type of material used to make the tailpiece has an effect on one or more sound characteristic of the cello. For example, to achieve more sound and brighter sound, tailpieces made of light material (in weight) and hard material are used. In another example, to achieve quieter and darker sound, tailpieces made of heavy material (in weight) and soft material are used. Additionally, a response rate of sound from the cello (i.e. a measurement of how fast the cello responds to plucking or bowing the cello) is affected by the type of material used to make the tailpiece. The inventor of the present invention recognized that existing materials used to make conventional tailpieces are limited in their ability to enhance one or more of these sound characteristics. The inventor of the present invention also recognized that the dimensions and/or shape of conventional tailpieces limit their ability to enhance one or more sound characteristics of the cello. Thus, the inventor developed an improved tailpiece made from a different material (carbon fiber) than existing tailpieces, to enhance one or more of these sound characteristics. Additionally, the inventor developed an improved tailpiece with different dimensions and/or shape than existing tailpieces, to enhance one or more of these sound characteristics.

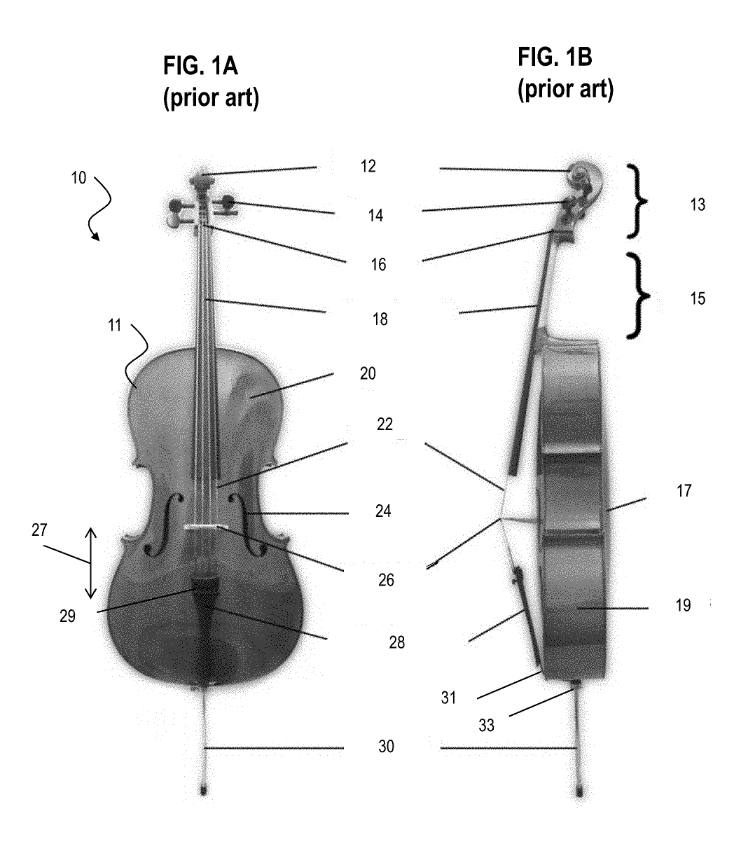

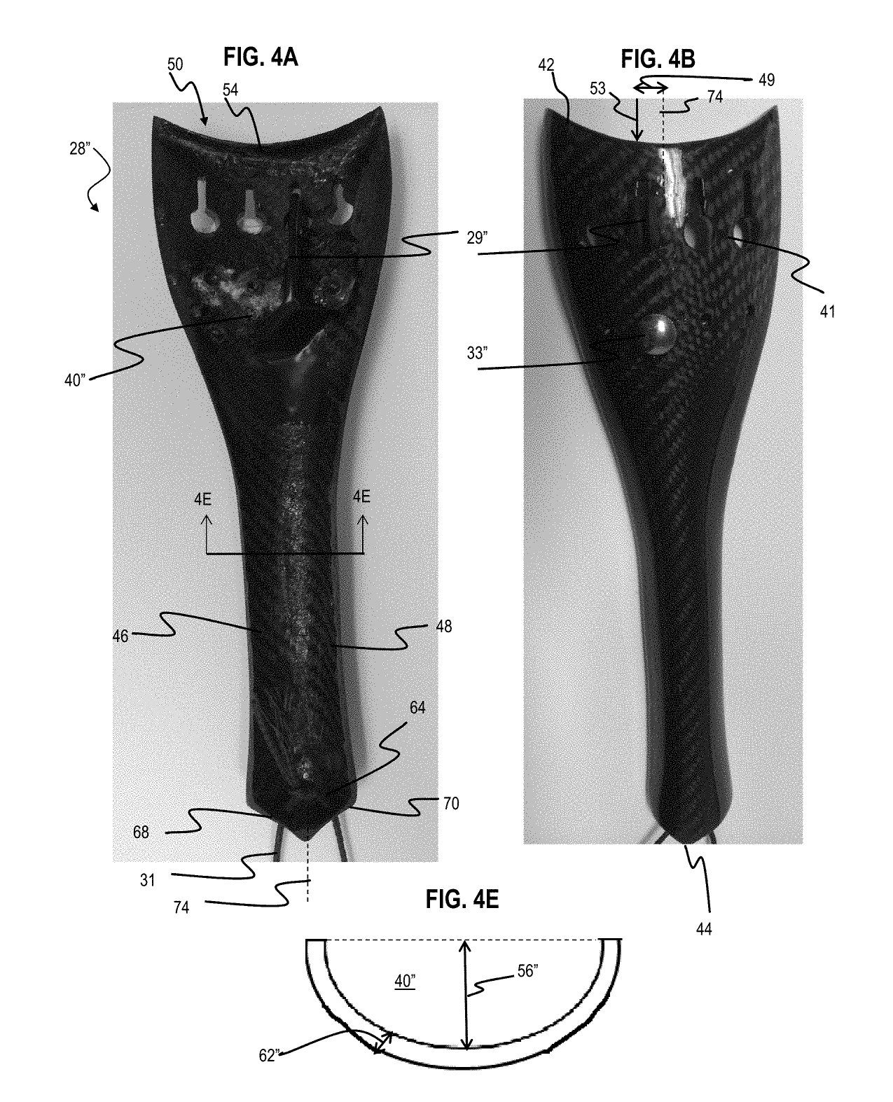

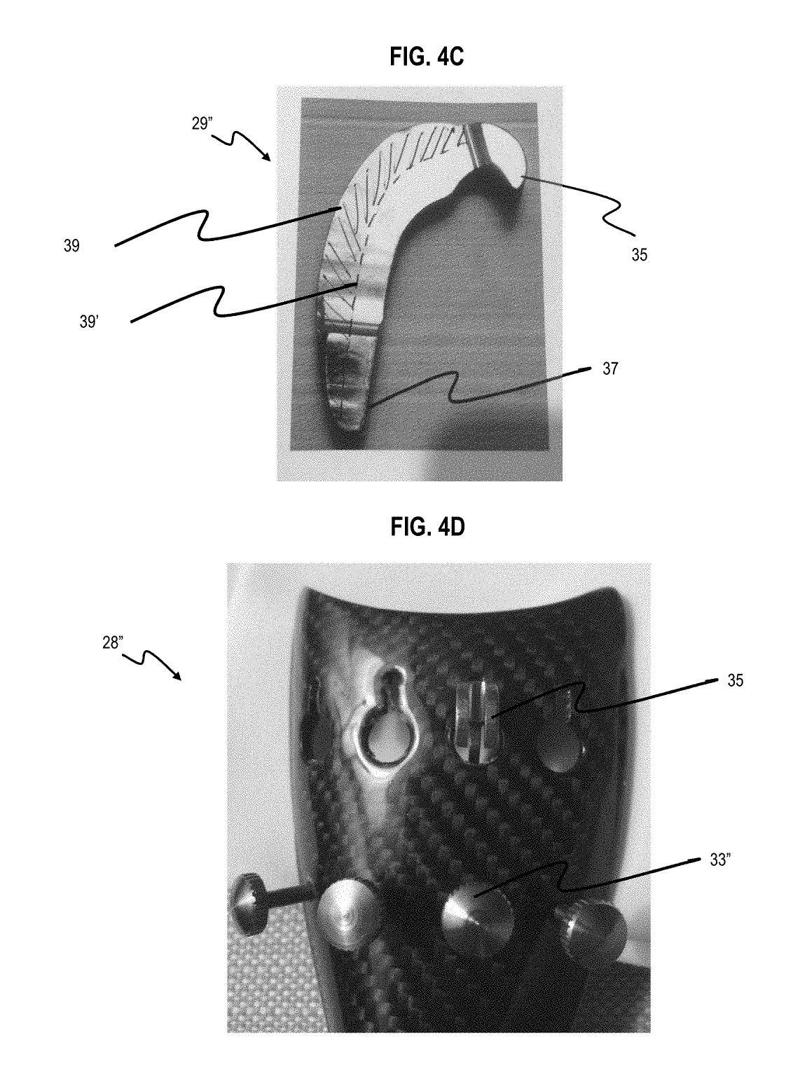

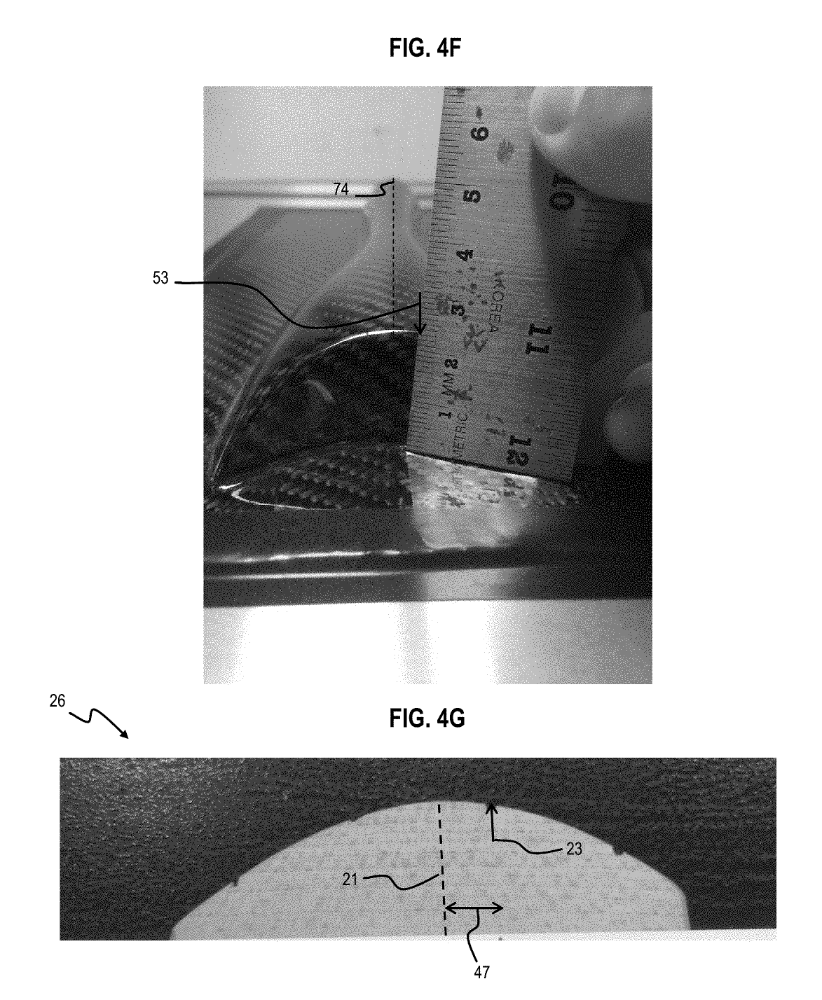

FIGS. 4A-4B are back face and front face views of a tailpiece 28″ according to one embodiment of the present invention. The tailpiece 28″ can replace the conventional tailpiece 28 of the cello 10 of FIGS. 1A-1B. However, the tailpiece 28″ is not restricted to use with the cello 10 and can be used with any string instrument, including a violin, a viola, a double bass, a guitar, a sitar, an electric bass, a harp, a rebab, a banjo, a mandolin, a ukulele and a bouzouki.

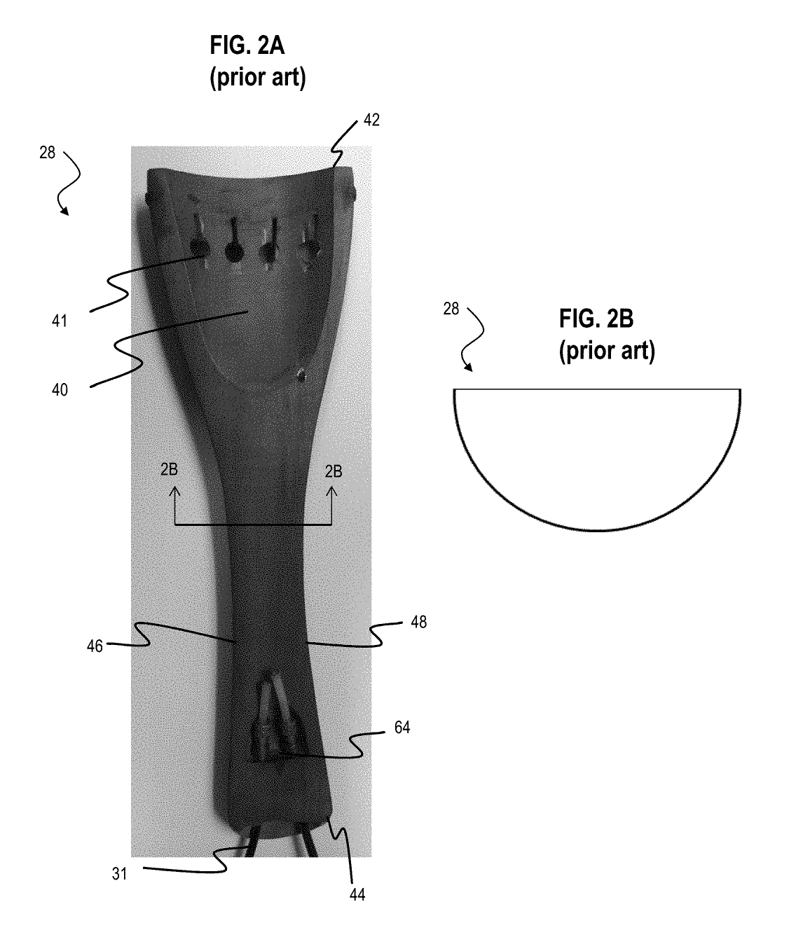

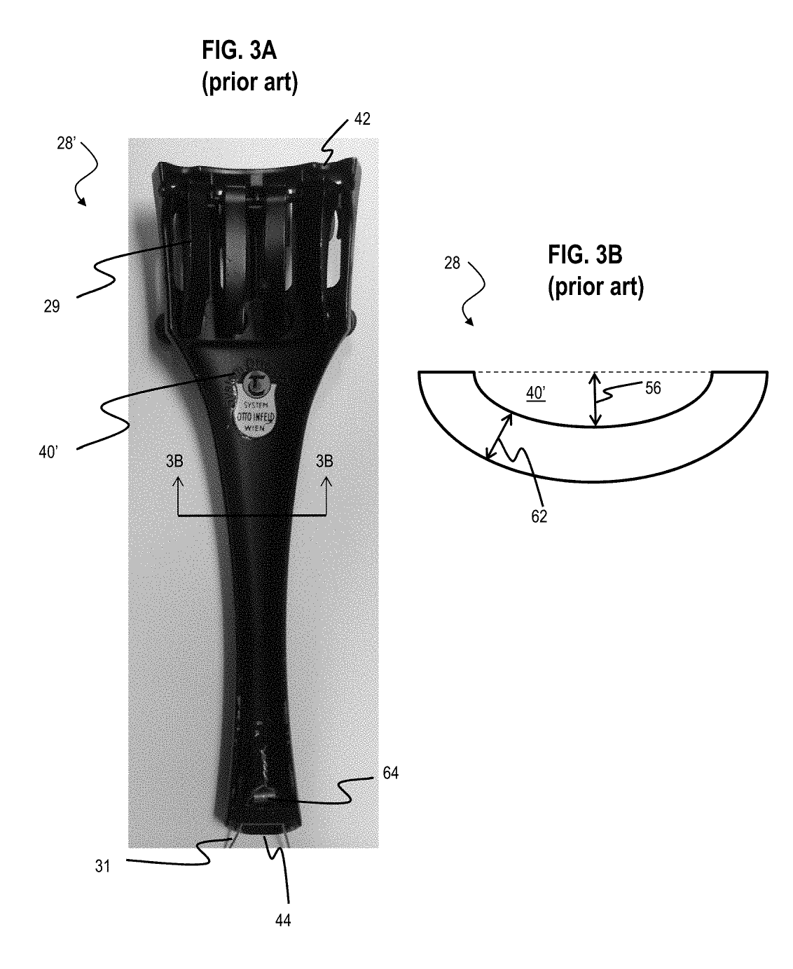

The tailpiece 28″ includes a cavity 40″ that extends from the top side 42 to the bottom side 44. In contrast, the cavity 40 of the conventional tailpiece 28 of FIG. 2A is restricted to the upper half of the tailpiece 28 and thus does not extend from the top side 42 to the bottom side 44. Additionally, in contrast, the cavity 40′ of the tailpiece 28′ of FIG. 3A extends from the top side 42 to the tailgut openings 64 positioned between the top and bottom side 42, 44 and thus does not extend from the top side 42 to the bottom side 44. In one embodiment, the larger cavity 40″ of the tailpiece 28″ enhances one or more sound characteristics of the cello 10. In an example embodiment, the larger cavity 40″ enhances a duration of a ringing tone from the cello 10. In one example, the duration of the ringing tone is increased by 30%.

In one embodiment, the tailpiece 28″ is made from carbon fiber material, which enhances a volume and brightness of sound from the cello 10. In an example embodiment, the tailpiece 28″ is made entirely from carbon fiber material. FIG. 4C is a side view of a string puller arm 29″ used with the tailpiece 28″ of FIG. 4A, according to one embodiment of the present invention. In some embodiments, the string puller arm 29″ is made of a material with a reduced thickness, relative to a thickness of a string puller arm made of plastic material. FIG. 4C depicts a first embodiment of the string puller arm 29″ with an exterior surface 39. In some embodiments, the string puller arm 29″ with the exterior surface 39 is based on a thickness of the string puller arm made of plastic material. FIG. 4C also depicts a second embodiment of the string puller arm 29″ with a reduced thickness based on an exterior surface 39′ formed by removing excess material from the string puller arm 29″ with the exterior surface 39. In an example embodiment, the second embodiment of the string puller arm 29″ is made of titanium material. As appreciated by one skilled in the art, a first end 35 of the string puller arm 29″ engages the string 22 and a second end 37 of the string puller arm 29″ engages a tuning adjuster screw 33″. FIG. 4D is a front view of the string puller arm 29″ of FIG. 4C used in the tailpiece 28″ of FIG. 4A, according to one embodiment of the present invention. In an example embodiment, the string puller arm 29″ and the tuning adjuster screw 33″ are made of titanium material, which enhances the duration of the ringing tone from the cello 10, and thus increases a volume and brightness of sound from the cello 10. In another embodiment, the tailgut 31 is made from braided Kevlar® material. However, the tailgut 31 is not limited to any specific material.

As shown in FIG. 4A, the top side 42 of the tailpiece 28″ is an arcuate surface 50 that extends from the left side 46 to the right side 48. Additionally, the arcuate surface 50 extends in a direction towards the bottom side 44, such that a trough 54 of the arcuate surface 50 between the left and right sides 46, 48 is positioned more proximate to the bottom side 44 than the arcuate surface 50 at the left and right sides 46, 48. In an example embodiment, the trough 54 is positioned at least 1 centimeter more proximate to the bottom side 44 than the arcuate surface 50 at the left and right sides 46, 48.

In an example embodiment, the arcuate surface 50 has a radius of curvature that is less than 20 centimeters. In another example embodiment, the arcuate surface 50 has a radius of curvature that is approximately 8 centimeters. In contrast, the top side 42 of the tailpieces 28, 28′ are not arcuate surfaces that extend in a direction towards the bottom side 44. In one embodiment, the arcuate surface 50 of the tailpiece 28″ enhances one or more sound characteristics of the cello 10. In an example embodiment, the arcuate surface 50 enhances the duration of the ringing tone of sound from the cello 10, such as an increased duration of 30%, for example.

FIG. 4E is a cross-sectional view of the tailpiece 28″ of FIG. 4A taken along the line 4E-4E. As shown in FIG. 4E, the tailpiece 28″ has a thickness 62″ and forms the cavity 40″. Additionally, the cavity 40″ has a depth 56″ which varies along the length of the cavity 40″ from the top end 42 to the bottom end 44. In one embodiment, the depth 56″ along the length of the cavity 40″ is greater than the depth 56 along the length of the cavity 40′ in the conventional tailpiece 28′ (FIG. 3B). In another embodiment, the thickness 62″ of the tailpiece 28″ is less than a thickness 62 of the conventional tailpiece 28 (FIG. 3B). In an example embodiment, a maximum value of the depth 56″ of the cavity 40″ between the top side 42 and the bottom side 44 is at least 1 centimeter. In another example embodiment, the maximum value of the depth 56″ is approximately 1.5 centimeters. In an example embodiment, a minimum value of the depth 56″ of the cavity 40″ between the top side 42 and the bottom side 44 is at least 0.5 centimeter. In another example embodiment, the minimum value of the depth 56″ is approximately 1 centimeter. In an example embodiment, the thickness 62″ of the tailpiece 28″ is less than 0.2 centimeters and preferably 0.1 centimeters. In an example embodiment, a ratio of the maximum value of the depth 56″ to the thickness 62″ is at least 7.

As shown in FIG. 4A, the bottom side 44 is a lower extremity of the tailpiece 28″ and includes a pair of openings 64 to receive tailgut 31. Additionally, the bottom side 44 includes a pair of intersecting surfaces 68, 70, where each intersecting surface 68, 70 has a tailgut opening 64. In an example embodiment, an angle between the intersecting surfaces 68, 70 is in a range of 70-110 degrees. In another example embodiment, the angle between the intersecting surfaces 68, 70 is approximately 90 degrees. As depicted in FIG. 4A, the pair of intersecting surfaces 68, 70 converge along a central longitudinal axis 74 of the tailpiece 28″. However, the intersecting surfaces 68, 70 need not converge along the central longitudinal axis 74.

As shown in FIGS. 4B and 4F, in some embodiments, the tailpiece 28″ features an asymmetrical design, where a peak height 53 of the tailpiece 28″ between the left and right sides 46, 48 is laterally offset from the central longitudinal axis 74. In an example embodiment, the peak height 53 of the tailpiece 28″ corresponds to the opening 41 in which the string puller arm 29″ is located in FIG. 4B. In an example embodiment, a lateral offset 49 between the peak height 53 and central longitudinal axis 74 is 1 centimeter (cm) or in a range of 0.5-2 cm. However, the lateral offset 49 is not limited to any specific value or range of values. As shown in FIG. 4G, the bridge 26 of the conventional cello 10 includes a peak height 23 that is laterally offset from a center 21 of the bridge 26 by a lateral offset 47 of 1 centimeter (cm) or in a range of 0.5-2 cm. However, the lateral offset 47 is not limited to any specific value or range of values. In some embodiments, the lateral offset 49 of the tailpiece 28″ is determined based on the lateral offset 47 of the bridge 26. In an example embodiment, the lateral offset 49 is adjusted so that a drop angle at the bridge 26, defined as a slope of the bridge 26 surface at a respective string, is approximately equal to a drop angle at the tailpiece 28″, defined as a slope of the tailpiece 28″ surface at the respective string.

As previously discussed, the tailpiece 28″ enhances one or more sound characteristics of the cello 10, when the tailpiece 28 is replaced with the tailpiece 28″. In one example embodiment, the tailpiece 28″ is configured to enhance a volume and brightness of a tone quality from the cello 10. In another example embodiment, the tailpiece 28″ is configured to enhance the duration of the ringing tone from the cello 10, such as an increased duration of 30%, for example. For example, the carbon fiber material used to make the tailpiece 28″ enhances the volume and brightness of sound from the cello 10. In this example embodiment, the carbon fiber material of the tailpiece 28″ increases a vibration of the strings 22, since the stiffness of the carbon fiber material transmits vibrations from the string 22 to the tailgut 31 at a faster rate which increases the volume and ringing tone duration of the sound.

In another example embodiment, the tailpiece 28″ enhances a quietness and darkness of sound from the cello 10. In an example embodiment, the quietness and darkness properties are enhanced, since an overall vibration of the cello 10 is less trapped with the tailpiece 28″ as compared to the conventional tailpiece 28, due to weight and stiffness properties of the carbon fiber material of the tailpiece 28″. In another example embodiment, the quietness and darkness properties are enhanced based on a faster travel rate of vibrations of the cello 10 from the bridge 26 to the tailgut 31. In another example embodiment, the tailpiece 28″ enhances one or more of a fundamental pitch, a vibrato, harmonics, glissandro, double stops and pizzicato sound characteristics of the cello 10. In an example embodiment, the carbon fiber material of the tailpiece 28″ enhances harmonic vibrations, since the response rate is faster. In another example embodiment, the carbon fiber material of the tailpiece 28″ makes playing double stops much easier and clearer.

One noticeable drawback of conventional tailpieces 28 is that in order to adjust a length of the tail gut 31 and vary the after length 27 (see FIG. 1A), the tailpiece 28 must be removed from the cello 10. As appreciated by one skilled in the art, removing the tailpiece 28 from the cello 10 eliminates all tension in the strings 22 and arbitrarily flexes the cello 10 (made of wood). Consequently, even if the same tailpiece 28 and strings 22 are placed back on the same cello 10, the sound of the cello 10 may change drastically. Thus, the inventor of the present invention recognized that it would be advantageous to develop a method to adjust the after length 27 of one or more of the strings 22 without removing the tailpiece 28 from the cello 10.

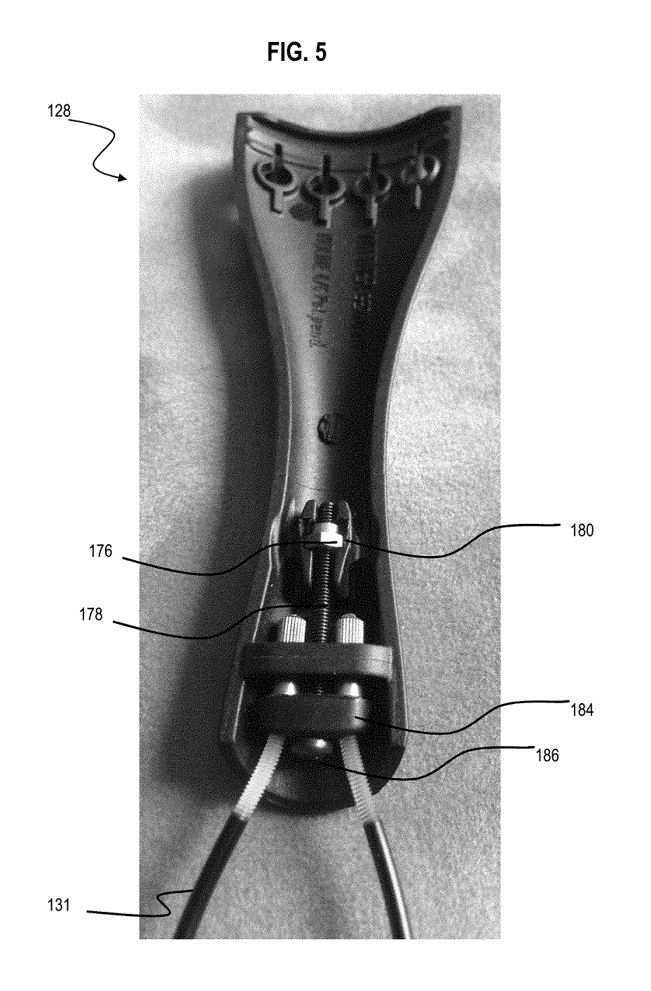

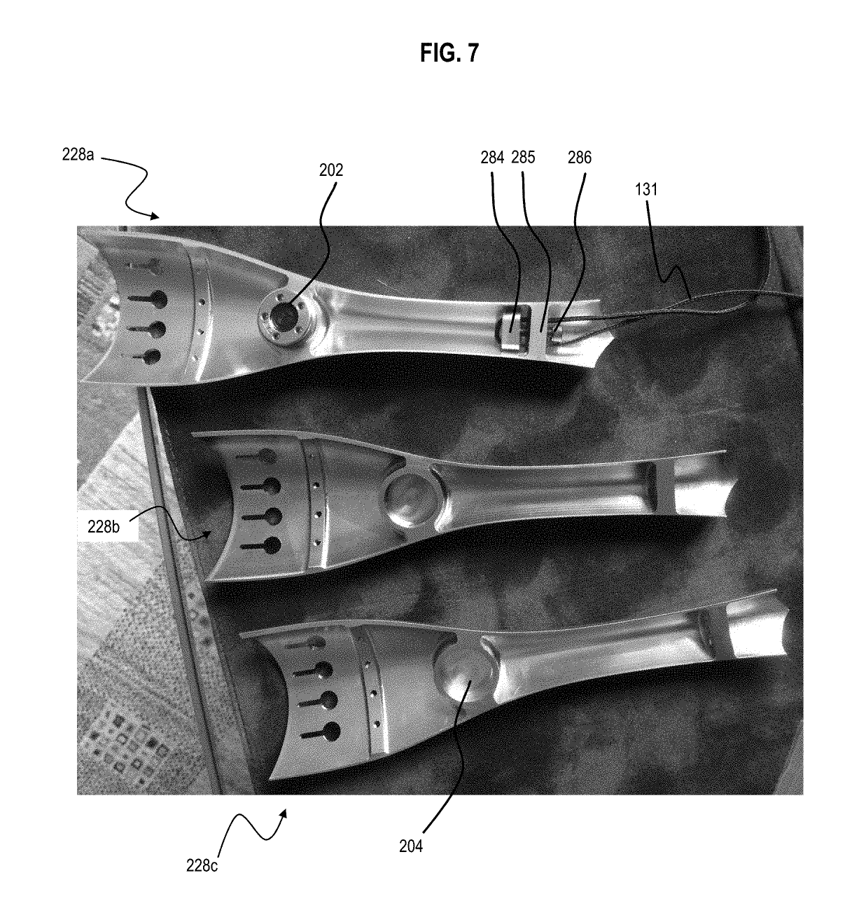

FIG. 5 is a rear perspective view of a tailpiece 128 according to one embodiment of the present invention. Opposite ends of the tail gut 131 are fixedly mounted to a lever 184 such that the ends of the tail gut 131 move with the lever 184. An adjustment screw 178 is passed through an opening in the lever 184 and is mounted in a bracket 180 with a nut 176. As a tool (e.g. Allen® wrench) adjusts a head 186 of the adjustment screw 178, the adjustment screw 178 rotates and translates within the bracket 180 (e.g. up/down in the perspective of FIG. 5). As the adjustment screw 178 moves up/down in the bracket 180, the tail gut 131 correspondingly moves up/down. In another embodiment, FIG. 7 depicts that opposite ends of the tail gut 131 are fixedly mounted to a lever 284 of a tailpiece 228a. The tail gut 131 is passed through openings (not shown) in a plate 285 and openings (not shown) in the lever 284 of the tailpiece 228a. An adjustment screw with a head 286 is mounted in an opening (not shown) in the plate 285 and a threaded end of the adjustment screw is received in a threaded opening (not shown) of the lever 284. As a tool (e.g. Allen® wrench) adjusts the head 286 of the adjustment screw, the adjustment screw moves the lever 284 up and down within the tailpiece 228a. As the lever 284 moves up and down in the tailpiece 228a, the tail gut 131 correspondingly moves up and down.

In an example embodiment, to increase the after length 27 of the strings 22, a length of the tail gut 131 between the tailpiece 128 and the end button 33 (FIG. 1A) is shortened. In this example embodiment, the adjustment screw 178 is moved upward which causes the tail gut 131 to move upward into the tailpiece 128 thereby causing a reduced distance between the tailpiece 128 and the end button 33.

In another example embodiment, to decrease the after length 27 of the strings 22, a length of the tail gut 131 between the tailpiece 128 and the end button 33 (FIG. 1A) is increased. In this example embodiment, the adjustment screw 178 is moved downward which causes the tail gut 131 to move downward out of the tailpiece 128 thereby causing an increased distance between the tailpiece 128 and the end button 33.

In some embodiments, the tailpiece 128 is positioned on the cello such that a minimum gap of is provided between the tailpiece 128 and the cello, such that a tool can be fitted in this gap to adjust the adjustment screw 178 without removing the tailpiece 128 from the cello.

In some embodiments, the tailpiece 128 provides macro-adjustment of the after length 27 of more than one string 22 without removing the tailpiece 128 from the cello. In an example embodiment, where all four strings 22 are connected using the tailpiece 128, the tailpiece 128 provides macro-adjustment of the after length 27 of all four strings 22 without removing the tailpiece 128 from the cello. An advantage of the tailpiece 128 is that is adjusts the after length 27 of the strings 22 without the noted drawbacks of removing the tailpiece from the cello (i.e. affecting the acoustic properties of the cello).

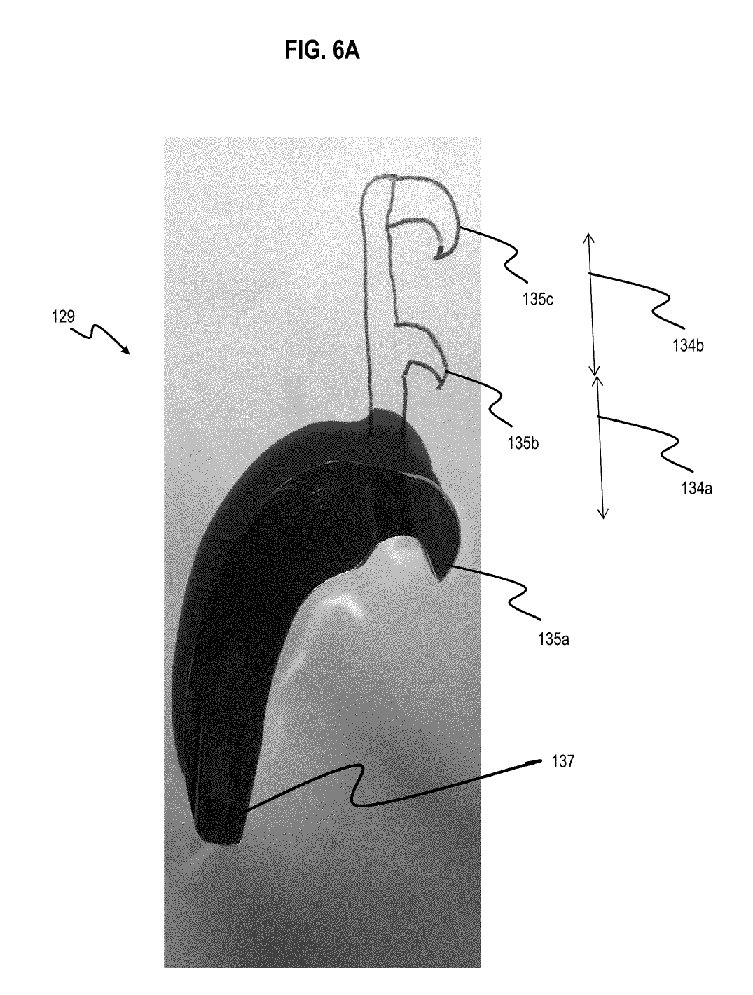

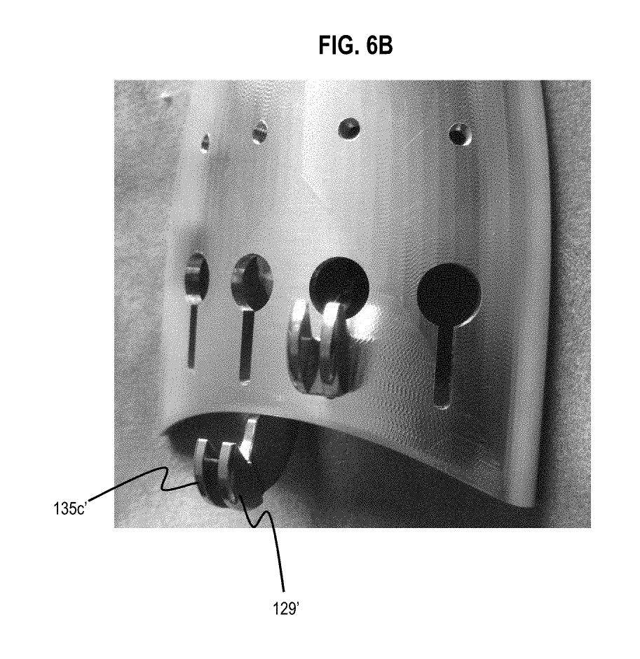

FIG. 6A is a side view of a string puller arm 129 for use with a tailpiece according to one embodiment of the present invention. The string puller arm 129 can be used with any tailpiece, including but not limited to the tailpieces disclosed in the embodiments of the present invention. The string puller arm 129 has a second end 137 that is similar to the second end 37 of the string puller arm 29″ which engages the tuning adjuster screw 33″. The string puller arm 129 also includes a plurality of hooks 135a, 135b, 135c that are spaced apart. In some embodiments, the string puller arm 129 is used during a testing phase to determine which of the hooks 135a, 135b, 135c is optimal for each string on a particular cello. Once the optimal hook 135a, 135b, 135c is determined, a string puller arm 129′ (FIG. 6B) is manufactured with a single hook 135c′ at the position of the determined optimal hook in the string puller arm 129. In one example embodiment, FIG. 6B depicts a string puller arm 129′ that is manufactured with the single hook 135c′ positioned based on a determined optimal hook 135c of the string puller arm 129 during the testing phase. In these embodiments, the string puller arm 129 is used during the testing phase and the manufactured string puller arm 129′ is used during a subsequent playing phase of the cello. An inner surface of the hooks 135a, 135b are spaced apart by a distance 134a, whereas an inner surface of the hooks 135b, 135c are spaced apart by a distance 134b. Each of the hooks 135a, 135b, 135c are configured to engage the string 22.

In some embodiments, to reduce the after length 27 of the string 22, the string 22 is released from the puller arm 129 and moved from the hook 135a to the hook 135b, from the hook 135a to the hook 135c or from the hook 135b to the hook 135c. In other embodiments, to increase the after length 27 of the string 22, the string 22 is released from the puller arm 129 and moved from the hook 135c to the hook 135b, from the hook 135c to the hook 135a or from the hook 135b to the hook 135a. Although FIG. 6A depicts that the string puller arm 129 features three hooks, the embodiment of the present invention is not limited to this arrangement and the string puller arm may feature less than three or more than three hooks that are arranged in a similar manner as depicted in FIG. 6A.

In some embodiments, the string puller arms 129, 129′ provide micro-adjustment of the after length 27 of one or more strings 22 without removing the tailpiece 128 from the cello. In an example embodiment, the micro-adjustment of the after length 27 of one or more strings 22 with the string puller arm 129 is provided in addition to the macro-adjustment of the after length 27 of all strings 22 using the adjustment screw 178 of the tailpiece 128. For example, the adjustment screw 178 is used to perform an overall macro-adjustment of the after length 27 of all strings 22, after which the string puller arm 129, 129′ of one string 22 can be used to perform a micro-adjustment of the after length 27 of the one string 22. An advantage of the string puller arm 129, 129′ is that it adjusts the after length 27 of one or more strings 22 without the noted drawbacks of removing the tailpiece from the cello (i.e. affecting the acoustic properties of the cello).

FIG. 7 is a top view of a plurality of tailpieces 228a, 228b, 228c and adjustable weights 202a according to one embodiment of the present invention. The tailpieces each include a slot 204 with internal threads. A weight 202 with external threads is secured in the slot 204 by engaging the external threads of the weight 202 with the internal threads of the slot 204. In other embodiments, other means for securing the weight 202 in the slot 204 are provided, such as a magnetic means or any other means appreciated by one of ordinary skill in the art. Additionally, although FIG. 7 depicts one slot 204 to receive one weight 202, the embodiment of the invention is not limited to this arrangement and includes more than one slot on the tailpiece to receive more than one weight.

A plurality of weights 202 of incremental weight are provided. In an example embodiment, the weights 202 have 5 gram increments between 5 grams and 40 grams. However, the weights 202 are not limited to any specific weight increment or range of weight. The weights 202 have an outer diameter of 22 mm or in a range of 10-30 mm and the slot 204 has an inner diameter of 20 mm or in a range of 10-30 mm, for example. The slot 204 is positioned and the weights 202 are sized such that a tool can be positioned between the tailpiece 228 and the cello to remove and replace the weights 202 while the tailpiece 228 is attached to the cello. In an example embodiment, a tool is used to remove the weights, such as a Scotty Cameron® Pivot Tool, for example. In an example embodiment, the weights 202 have a height not more than 10 mm so to fit in a gap between the tailpiece 228 and the cello. In an example embodiment, the height of the weights 202 is approximately 7.5 mm or in a range of 5-10 mm

The tailpieces 228a, 228b, 228c are made of material of different weight. In an example embodiment, the tailpiece 228a is made of Aluminum, the tailpiece 228b is made of Titanium and the tailpiece 228c is made of Brass or Copper. However, the tailpieces 228a, 228b, 228c are not limited to any specific type of material, such as Aluminum, Titanium, Brass or Copper. Additionally, the tailpieces are not limited to three materials of different weight and can include less or more than three materials of different weight.

One or more sound characteristics of the cello can be adjusted by varying a weight of the tailpiece. In some embodiments, a user begins with a tailpiece 228a of light weight (e.g. Aluminum) and positions a weight 202 of minimum weight (e.g. 5 grams) in the slot 204. In an example embodiment, an Aluminum tailpiece has a weight in a range of 85-100 grams. The user then uses the tool to replace the weight 202 with incremental weights (e.g. 10 grams, 15 grams, 20 grams, 25 grams, 30 grams, 35 grams, 40 grams) until a heaviest weight 202 is positioned in the slot 204.

If a desired sound characteristic is not achieved while replacing the weights 202 in the tailpiece 228a, the user replaces the tailpiece 228a with the tailpiece 228b of medium weight (e.g. Titanium) and positions the weight 202 of minimum weight (e.g. 5 grams) in the slot 204. In an example embodiment, a Titanium tailpiece has a weight of approximately 185 grams. The user then uses the tool to replace the weight 202 with incremental weights (e.g. 10 grams, 15 grams, 20 grams, 25 grams, 30 grams, 35 grams, 40 grams) until a heaviest weight 202 is positioned in the slot 204.

If a desired sound characteristic is not achieved while replacing the weights 202 in the tailpiece 228b, the user replaces the tailpiece 228b with the tailpiece 228c of heavy weight (e.g. Brass or Copper) and positions the weight 202 of minimum weight (e.g. 5 grams) in the slot 204. The user then uses the tool to replace the weight 202 with incremental weights (e.g. 10 grams, 15 grams, 20 grams, 25 grams, 30 grams, 35 grams, 40 grams) until a heaviest weight 202 is positioned in the slot 204.

In some embodiments, a lighter tailpiece provides a more focused tone whereas a heaver tailpiece provides a warmer tone. In some embodiments, the combination of adjusting the tailpieces 228a, 228b, 228c and weights 202 within the tailpieces permits an adjustment of the tailpiece weight within a range, such as from 90 grams to 500 grams, for example. However, the weight range of the tailpiece is not limited to this numerical range and includes any numerical range based on the material of the tailpiece and incremental size of the weights 202.

As with the adjustment screw 176 and string puller arm 129, the replacement of incremental weights 202 permits a user to adjust one or more sound characteristics of the cello without removing the tailpiece from the cello. Although replacement of the tailpiece 228a, 228b, 228c with a tailpiece of another material involves removing the tailpiece from the cello, the removal and replacement of the incremental weights 202 within the slot 204 of each tailpiece does not involve removing the tailpiece from the cello and thus advantageously avoids the notable drawbacks of removing the tailpiece from the cello (i.e. drastic altering of the sound characteristics of the cello).

Finally, while various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims. The teachings of all patents and other references cited herein are incorporated herein by reference to the extent they are not inconsistent with the teachings herein.

1. A tailpiece for a stringed instrument, the tailpiece comprising
a top end, a bottom end, a front face, a back face, a left side and a right side, wherein the tailpiece defines
(i) a cavity on its back face;
(ii) at least one tailgut opening; and
(iii) at least one string opening
wherein the tailpiece is comprised of carbon fiber; a peak height of the tailpiece between the left and right sides that is laterally offset from the central longitudinal axis or both.

2. The tailpiece of claim 1, further comprising at least one string puller arm positioned in the at least one string opening.

3. The tailpiece of claim 1, wherein the lateral offset is 0.5-2 cm from a central longitudinal axis.

4. The tailpiece of claim 1, wherein the lateral offset is configured so that a drop angle at a bridge of the stringed instrument is approximately equal to a drop angle at the tailpiece.

5. (canceled)

6. A tailpiece for a stringed instrument, the tailpiece comprising
a top end, a bottom end, a front face, a back face, a left side and a right side, wherein the tailpiece defines (i) a cavity on its back face; (ii) at least one tailgut opening; and (iii) at least one string opening; and at least one of the following:
a) an adjustment screw having a first end associated with the lever and passing through a plate on the back face such that rotation of the adjustment screw moves the lever;
b) a detachable weight associated with the tailpiece; and
c) a lever positioned o the back face to which a tail gut attached; and an adjustment screw having a first end associated with a nut mounted to a bracket on the back face and a second end associated with the lever such that rotation of the adjustment screw moves the lever.

7. The tailpiece of claim 6, wherein the plate has a threaded opening through which the adjustment screw passes.

8. (canceled)

9. The tailpiece of claim 6, wherein the detachable weight is positioned in the cavity.

10. The tailpiece of claim 6, wherein the tailpiece comprises at least two string puller arms, wherein the at least two string puller arms have a different length.

11. A string puller arm for use with a tailpiece of a stringed instrument, the string puller arm having two or more hooks spaced along a length of the string puller arm onto which strings can be engaged.
